(19) United States
(12) Patent Application Publication
(10) Pub. No.: US 2017/0154288 A1
(43) Pub. Date: Jun. 1, 2017

(54) DATA ENTRY SELECTION BASED ON DATA PROCESSING

(71) Applicant: Accenture Global Solutions Limited, Dublin (IE)

(72) Inventors: Christine E. BARNUM, Washington, DC (US); Keelyn HENDERSON, Washington, DC (US)

(21) Appl. No.: 14/983,815

(22) Filed: Dec. 30, 2015

Related U.S. Application Data
(60) Provisional application No. 62/260,815, filed on Nov. 30, 2015.

(51) Int. Cl. G06Q 10/06; G06F 17/30

(52) U.S. Cl. CPC G06Q 10/06313; G06F 17/30867; G06F 17/30554; G06F 17/3053; G06Q 10/0637

(57) ABSTRACT

A device may communicate with one or more data sources to obtain data including a set of data entries and a set of groups of metadata entries. A group of metadata entries may correspond to a data entry of the set of data entries. The device may determine a set of filtering criteria associated with filtering the data. The device may process the data to select a subset of data entries, of the data, based on the set of filtering criteria. The subset of data entries may correspond to a subset of groups of metadata entries of the set of groups of metadata entries. The device may automatically evaluate the subset of groups of metadata entries to determine a set of scores for the subset of data entries. The device may provide, for display via a user interface, information identifying the set of scores for the subset of data entries.

### RELATED APPLICATION(S)

This application claims priority under 35 U.S.C. §119 to U.S. Provisional Patent Application 62/260,815, filed on Nov. 30, 2015, the content of which is incorporated by reference herein in its entirety.

### BACKGROUND

Data entries, of a set of data entries, may be associated with respective groups of metadata entries. The metadata entries may be associated with describing characteristics of the data entries. The metadata entries may be stored via multiple data sources, such as via one or more servers associated with one or more websites, one or more databases, or the like. The set of data entries may relate to a project. For example, the set of data entries may represent a set of locations at which to assign resources for establishing an educational program and the set of metadata entries may represent characteristics of the set of locations.

### SUMMARY

According to some possible implementations, a device may include one or more processors. The one or more processors may communicate with one or more data sources to obtain data from the one or more data sources. The data may include a set of data entries. The data may include a set of groups of metadata entries. A group of metadata entries, of the set of groups of metadata entries may correspond to a data entry of the set of data entries. The one or more processors may determine a set of filtering criteria associated with filtering the data. The one or more processors may process the data to select a subset of data entries, of the data, based on the set of filtering criteria. The subset of data entries may correspond to a subset of groups of metadata entries of the set of groups of metadata entries. The one or more processors may automatically evaluate the subset of groups of metadata entries to determine a set of scores for the subset of data entries. The one or more processors may provide, for display via a user interface, information identifying the set of scores for the subset of data entries.

According to some possible implementations, a non-transitory computer-readable medium may store one or more instructions that, when executed by one or more processors may cause the one or more processors to obtain a set of datasets relating to a set of characteristics of a set of locations for a project. One or more datasets, of the set of datasets, may be stored via one or more data structures. The one or more instructions, when executed by the one or more processors, may cause the one or more processors to correlate metadata entries, of the set of datasets, into groups of metadata entries. A group of metadata entries may relate to the set of characteristics of a particular location of the set of locations. The one or more instructions, when executed by the one or more processors, may cause the one or more processors to select, from the set of locations, a subset of locations based on a set of filtering criteria. The one or more instructions, when executed by the one or more processors, may cause the one or more processors to evaluate a subset of groups of metadata entries, of the groups of metadata entries, that are associated with the subset of locations. The one or more instructions, when executed by the one or more processors, may cause the one or more processors to provide information identifying one or more locations, of the subset of locations, for the project. The information may identify the one or more locations including information identifying a feasibility of implementing the project at the one or more locations and a value of implementing the project at the one or more locations.

According to some possible implementations, a method may include identifying, by a device, a group of datasets relating to a decision to implement a program. The group of datasets may include groups of metadata entries regarding a set of data entries. The method may include determining, by the device, a set of filtering criteria relating to the decision to implement the program. The method may include selecting, by the device, two or more groups of metadata entries, of the groups of metadata entries, that satisfy the set of filtering criteria. The two or more groups of metadata entries may relate to two or more data entries of the set of data entries. The method may include evaluating, by the device, the two or more groups of metadata entries to generate two or more scores corresponding to the two or more data entries. A score of the two or more scores, may be a composite score based on two or more component scores. Each component score, of the two or more component scores, may be related to a value of a particular metadata entry, of a particular group of metadata entries, relative to one or more values of one or more other corresponding metadata entries of one or more other groups of metadata entries of the two or more groups of metadata entries. The method may include providing, by the device, information identifying the two or more scores.

### BRIEF DESCRIPTION OF THE DRAWINGS

FIGS. 1A and 1B are diagrams of an overview of an example implementation described herein;

FIG. 2 is a diagram of an example environment in which systems and/or methods, described herein, may be implemented;

FIG. 3 is a diagram of example components of one or more devices of FIG. 2;

FIG. 4 is a flow chart of an example process for selecting a data entry from a set of data entries; and

FIGS. 5A-5D are diagrams of an example implementation relating to the example process shown in FIG. 4.

### DETAILED DESCRIPTION

The following detailed description of example implementations refers to the accompanying drawings. The same reference numbers in different drawings may identify the same or similar elements.

A data entry, of a set of data entries, may be associated with a set of characteristics. The set of characteristics may be represented via groups of metadata entries. For example, a data entry identifying a potential location for assigning resources (e.g., selecting a city for implementing an educational program, selecting a site for a government building, selecting a region for expanding a commercial operation, etc.) may be associated with a metadata entry identifying characteristics of the potential location (e.g., a graduation rate for a school at the potential location, an average income for residents of the potential location, a quantity of market competitors doing business at the potential location, etc.). A user may desire to select a particular data entry from a set of data entries based on information included in a particular group of metadata entries associated with the particular data entry. For example, the user may desire to identify a particular potential location, from a set of potential locations, at which to assign resources for an educational program based on the graduation rate for a school at the particular potential location.

However, selecting a particular data entry from a set of data entries based on a group of associated metadata entries may be difficult, time-consuming, resource-intensive, and lack consistency as the quantity of metadata entries in each group of metadata entries increases. Implementations, described herein, may select one or more data entries from a set of data entries based on groups of metadata entries associated with the set of data entries. In this way, a decision relating to selection of the one or more data entries may be performed in an accurate, repeatable manner. Moreover, based on automatically filtering the data, memory resources associated with storing the metadata, processing resources associated with analyzing the metadata, or the like may be reduced relative to analyzing all data entries of a set of data entries.

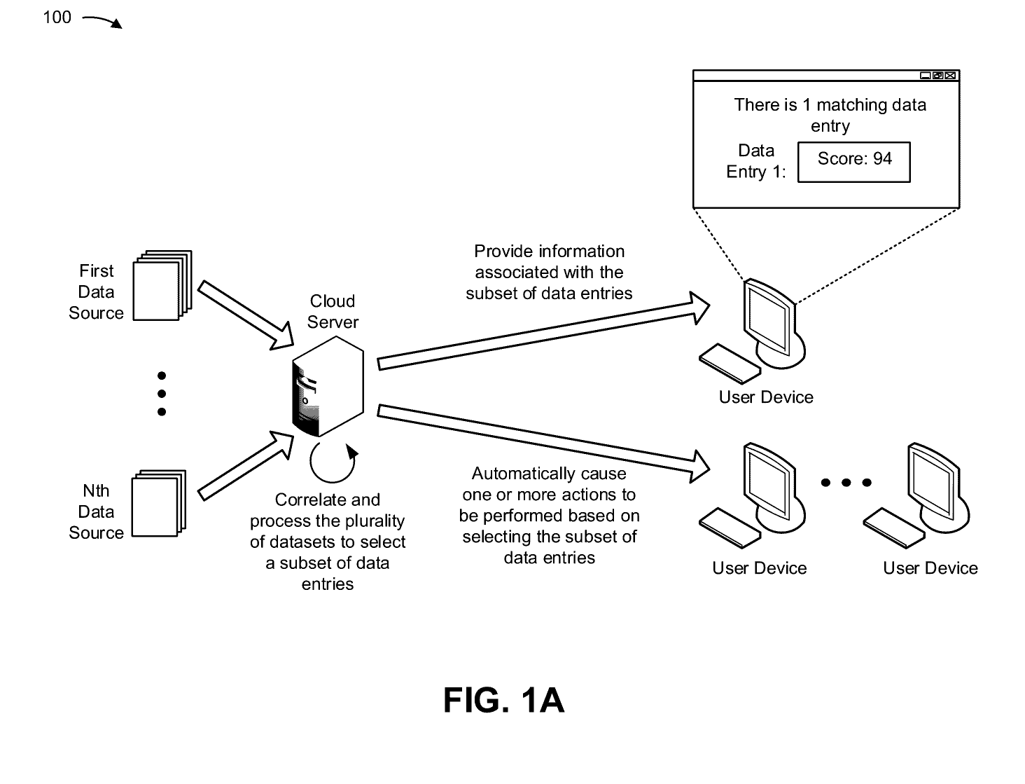

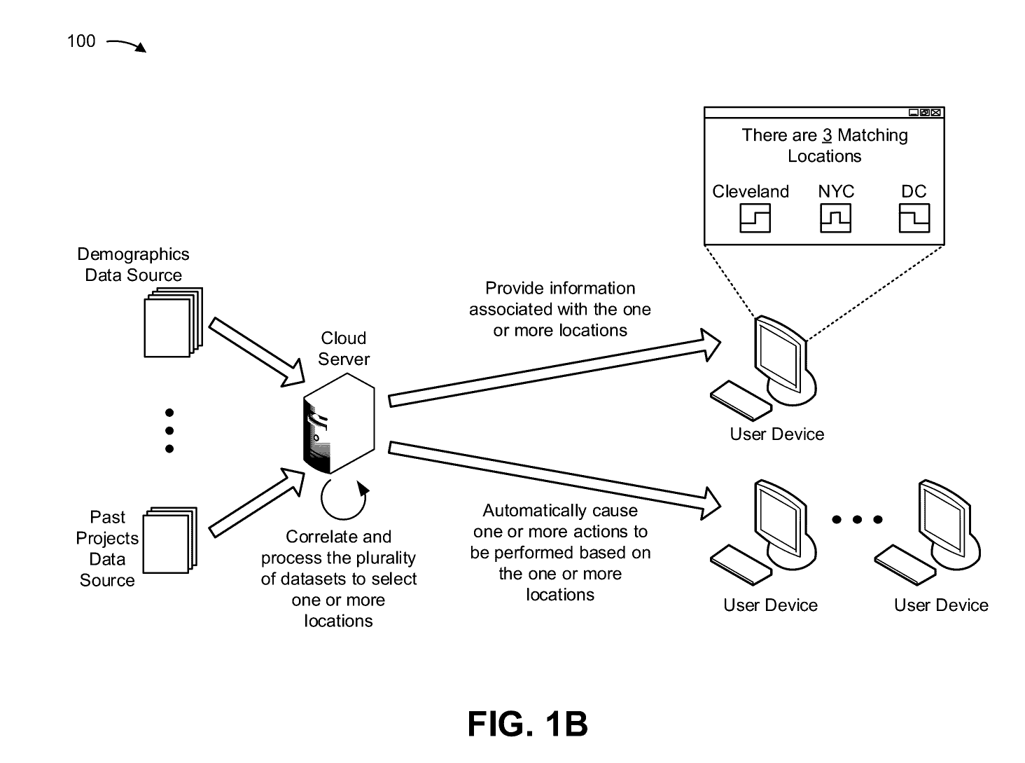

FIGS. 1A and 1B are diagrams of an overview of an example implementation 100 described herein. As shown in FIG. 1A, example implementation 100 includes a set of data sources (e.g., server devices storing data entries, metadata entries, or the like), a cloud server, and a set of user devices.

As further shown in FIG. 1A, the cloud server may obtain multiple datasets from multiple data sources. For example, the cloud server may determine that the multiple datasets include metadata entries relating to a set of data entries. The cloud server may correlate the metadata entries to the set of data entries. For example, the cloud server may determine that a particular data entry is associated with a particular group of metadata entries. As another example, the cloud server may identify a format associated with a first dataset and may convert the first dataset to another format to merge the first dataset with a second dataset. In this case, the merged first dataset and second dataset may, collectively, be utilized as metadata for the set of data entries. The cloud server may select a particular subset of data entries, of the set of data entries, based on a set of threshold filtering criteria. For example, the cloud server may determine that a particular type of numeric metadata entry associated with a particular data entry satisfies a numeric threshold, and may select the particular data entry to include in the particular subset of data entries.

The cloud server may perform one or more data analysis techniques to evaluate groups of metadata entries associated with the particular subset of data entries. For example, the cloud server may determine a ranking of the particular subset of data entries, generate a set of tiers for the particular subset of data entries, select a particular data entry from the particular subset of data entries, or the like. The cloud server may provide information associated with the subset of data entries based on performing the one or more data analysis techniques. For example, the cloud server may identify a score associated with the subset of data entries, generate a graph representing scores for a set of criteria associated with the subset of data entries, or the like. The cloud server may automatically cause one or more actions to be performed. For example, the cloud server may generate a set of calendar entries relating to a particular data entry of the subset of data entries, allocate a quantity of effort to the particular data entry, allocate a portion of a budget to the particular data entry, or the like based on a score associated with the particular data entry.

With regard to FIG. 1B, assume that a user desires to select a particular location, from a set of locations, at which to implement an educational program. Based on a trigger (e.g., based on a user interaction with a user interface), a cloud server may obtain multiple datasets from multiple data sources. For example, the cloud server may obtain demographics information regarding a set of locations, information regarding a set of past projects implemented at the set of locations (e.g., a success of a past project, a cost of a past project, etc.), or the like. In some implementations, the cloud server may perform a data mining technique to obtain one or more datasets of the multiple datasets. The cloud server may correlate the multiple datasets to the set of locations. For example, the cloud server may determine, for a particular location and based on the multiple datasets, a high school graduation rate at the particular location, a quantity of freshman at a high school at the particular location, an expected amount of funding from private individuals for schools at the particular location, a percentage of schools at the particular location that satisfy a need classification, a quantity of Fortune 1000 companies with operations at the particular location, a size of an entrepreneurship discussion group that meets at the particular location, or the like.

The cloud server may filter the set of locations based on a set of filtering criteria. For example, the cloud server may determine to analyze locations in the Eastern United States, in California, in Western Texas, or the like. Similarly, the cloud server may filter the set of locations based on one or more filtering criteria relating to the multiple datasets associated with the set of locations. For example, the cloud server may select a subset of locations that satisfy one or more thresholds, such as a threshold high school graduation rate, a threshold quantity of Fortune 1000 companies, or the like. In this way, the cloud server reduces memory resources and processing resources relative to performing analysis on all locations of the set of locations. In some implementations, the cloud server may select the subset of locations based on a set of selection criteria received via a user interface, based on the data relating to the set of past projects, or the like.

The cloud server may evaluate information regarding the subset of locations. For example, the cloud server may assign weights to characteristics of each location, such as a first weight to a quantity of students, a second weight to a high school graduation rate, a third weight to the expected amount of funding from private individuals, or the like. In some implementations, the cloud server may scale the characteristics. For example, the cloud server may determine the high school graduation rate as a percentage of a maximum high school graduation rate included in a dataset of high school graduation rates. The cloud server may determine one or more scores for each location of the subset of locations based on assigning weights to the characteristics. For example, the cloud server may determine, for a particular location, a first score relating to a feasibility of establishing the educational program at the particular location, a second score relating to an expected value to students from establishing the educational program at the particular location, or the like.

The cloud server may provide, via a user interface, information regarding the subset of locations based on analyzing characteristics of the subset of locations. For example, the cloud server may generate a graph with a first axis representing the first score and a second axis representing the second score. Additionally, or alternatively, the cloud server may determine a combined score for a location based on the first score and the second score, and may identify the subset of locations in an order based on combined scores. Additionally, or alternatively, the cloud server may provide information identifying tiers of the subset of locations. For example, the cloud server may perform a clustering analysis to assign a first group of locations to a first tier, a second group locations to a second tier, or the like, and may provide information identifying the tiers. In this case, the cloud server may perform actions based on a tier to which a particular location is assigned. For example, the cloud server may assign a first budget allocation to each location of a first tier and a second, lesser budget allocation to each location of a second tier.

In some implementations, the cloud server may provide additional information regarding a particular location. For example, the cloud server may select a particular location of the subset of locations associated with the greatest score, and may dynamically update a user interface to provide information identifying characteristics of the particular location. In this case, the information identifying characteristics of the particular location may include information indicating which characteristics received higher scores than corresponding characteristics for other locations, which characteristics received lower scores than corresponding characteristics for other locations, which characteristics are projected to change after a period of time, which characteristics are projected to change based on establishing the educational program, or the like.

The cloud server may automatically cause one or more actions to be performed based on analyzing the characteristics associated with the subset of locations. For example, the cloud server may automatically allocate portions of a budget to projects associated with one or more locations, of the subset of locations, based on the one or more locations being associated with higher scores than other locations of the subset of locations. Similarly, the cloud server may automatically allocate a quantity of employees, a quantity of man-hours, or the like to causing projects to be implemented at the one or more locations. The cloud server may automatically generate calendar entries for a meeting to discuss a particular location and may transmit alerts to the set of user devices regarding the one or more meetings, may automatically generate a press release regarding the one or more locations, or the like.

In this way, the cloud server may permit selection of a location at which to assign resources for a project based on characteristics of the location. Moreover, based on filtering data regarding a set of locations and analyzing a subset of locations based on filtering the data, the cloud server reduces memory resources and/or processing resources relative to analyzing all locations of the set of locations. Furthermore, based on obtaining and automatically analyzing multiple datasets, the cloud server may permit a user to make a rapid decision thereby improving responsiveness to time-sensitive decision requirements.

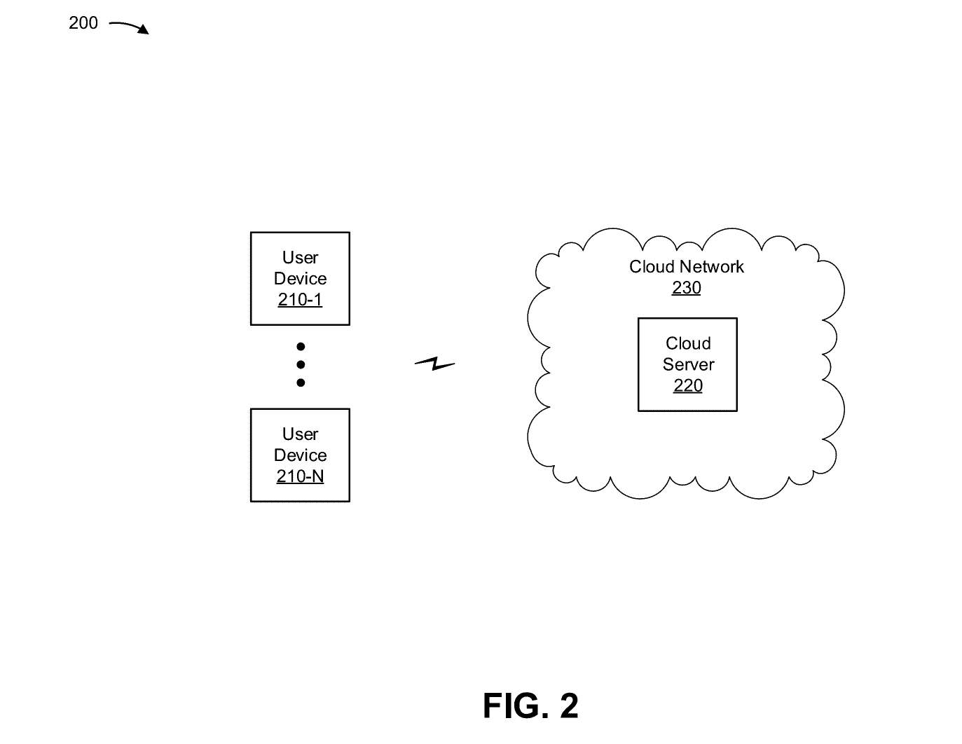

FIG. 2 is a diagram of an example environment 200 in which systems and/or methods, described herein, may be implemented. As shown in FIG. 2, environment 200 may include one or more user devices 210-1 through 210-N (N≧1) (hereinafter referred to collectively as “user devices 210,” and individually as “user device 210”), a cloud server 220, and a cloud network 230. Devices of environment 200 may interconnect via wired connections, wireless connections, or a combination of wired and wireless connections.

User device 210 may include one or more devices capable of receiving, generating, storing, processing, and/or providing information associated with selecting a location for a project. For example, user device 210 may include a communication and/or computing device, such as a mobile phone (e.g., a smart phone, a radiotelephone, etc.), a computer (e.g., a laptop computer, a tablet computer, a handheld computer, a desktop computer, etc.), a wearable communication device (e.g., a smart wristwatch, a pair of smart eyeglasses, etc.), or a similar type of device. In some implementations, user device 210 may receive information from and/or transmit information to another device in environment 200.

Cloud server 220 may include one or more devices capable of storing, processing, and/or routing information associated with selecting a location for a project. For example, cloud server 220 may include a server that is associated with analyzing demographics information to select a location at which to establish an educational program, open a government office, expand a commercial operation, or the like. In some implementations, cloud server 220 may include a communication interface that allows cloud server 220 to receive information from and/or transmit information to other devices in environment 200. While cloud server 220 is described as a resource in a cloud computing network, such as cloud network 230, cloud server 220 may operate external to a cloud computing network, in some implementations.

Cloud network 230 may include an environment that delivers computing as a service, whereby shared resources, services, etc. may be provided by cloud server 220 to store, process, and/or route information associated with selecting a location for a project. Cloud network 230 may provide computation, software, data access, storage, and/or other services that do not require end-user knowledge of a physical location and configuration of a system and/or a device that delivers the services (e.g., cloud server 220). As shown, cloud network 230 may include cloud server 220 and/or may communicate with user device 210 via one or more wired or wireless networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. For example, although user device 210 and cloud server 220 are described as separate devices, user device 210 and cloud server 220 may be implemented via a single device. Additionally, or alternatively, a set of devices (e.g., one or more devices) of environment 200 may perform one or more functions described as being performed by another set of devices of environment 200.

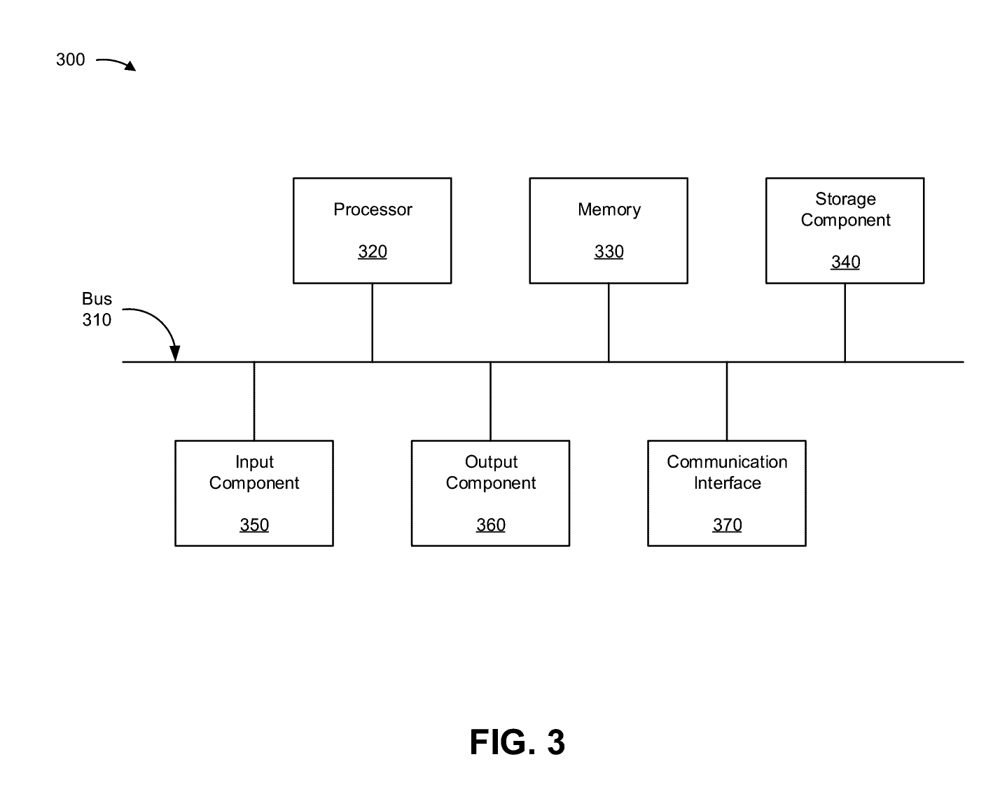

FIG. 3 is a diagram of example components of a device 300. Device 300 may correspond user device 210 and/or cloud server 220. In some implementations, user device 210 and/or cloud server 220 may include one or more devices 300 and/or one or more components of device 300. As shown in FIG. 3, device 300 may include a bus 310, a processor 320, a memory 330, a storage component 340, an input component 350, an output component 360, and a communication interface 370.

Bus 310 may include a component that permits communication among the components of device 300. Processor 320 is implemented in hardware, firmware, or a combination of hardware and software. Processor 320 may include a processor (e.g., a central processing unit (CPU), a graphics processing unit (GPU), an accelerated processing unit (APU), etc.), a microprocessor, and/or any processing component (e.g., a field-programmable gate array (FPGA), an application-specific integrated circuit (ASIC), etc.) that interprets and/or executes instructions. In some implementations, processor 320 may include one or more processors that can be programmed to perform a function. Memory 330 may include a random access memory (RAM), a read only memory (ROM), and/or another type of dynamic or static storage device (e.g., a flash memory, a magnetic memory, an optical memory, etc.) that stores information and/or instructions for use by processor 320.

Storage component 340 may store information and/or software related to the operation and use of device 300. For example, storage component 340 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of non-transitory computer-readable medium, along with a corresponding drive.

Input component 350 may include a component that permits device 300 to receive information, such as via user input (e.g., a touch screen display, a keyboard, a keypad, a mouse, a button, a switch, a microphone, etc.). Additionally, or alternatively, input component 350 may include a sensor for sensing information (e.g., a global positioning system (GPS) component, an accelerometer, a gyroscope, an actuator, etc.). Output component 360 may include a component that provides output information from device 300 (e.g., a display, a speaker, one or more light-emitting diodes (LEDs), etc.).

Communication interface 370 may include a transceiver-like component (e.g., a transceiver, a separate receiver and transmitter, etc.) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, or the like.

Device 300 may perform one or more processes described herein. Device 300 may perform these processes in response to processor 320 executing software instructions stored by a non-transitory computer-readable medium, such as memory 330 and/or storage component 340. A non-transitory computer-readable medium is defined herein as a non-transitory memory device. A memory device includes memory space within a single physical storage device or memory space spread across multiple physical storage devices.

Software instructions may be read into memory 330 and/or storage component 340 from another non-transitory computer-readable medium or from another device via communication interface 370. When executed, software instructions stored in memory 330 and/or storage component 340 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 3 are provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

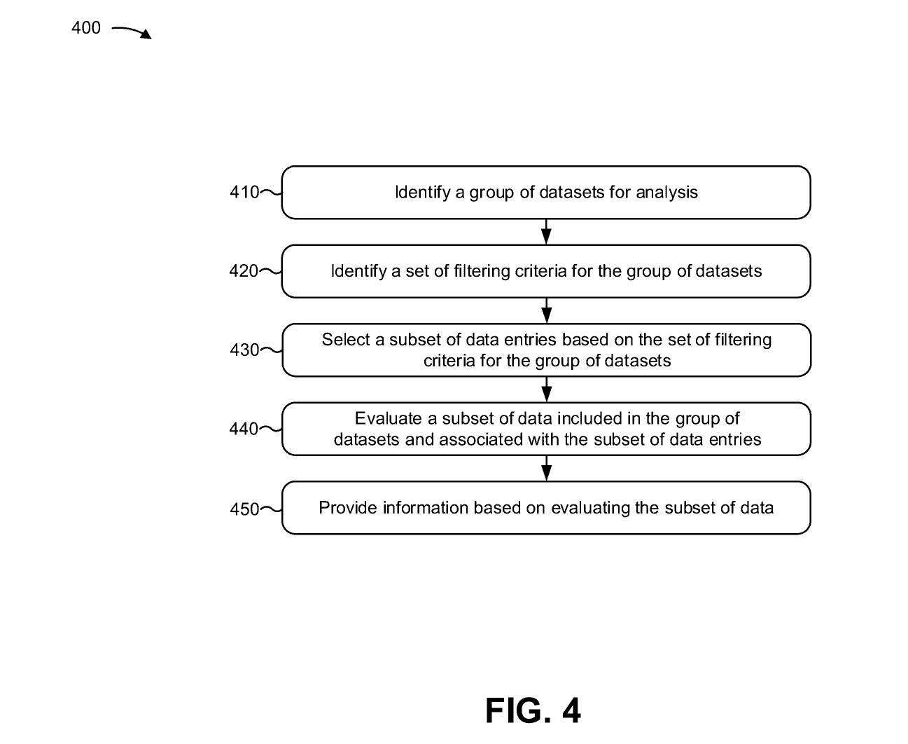

FIG. 4 is a flow chart of an example process 400 for selecting a data entry from a set of data entries. In some implementations, one or more process blocks of FIG. 4 may be performed by cloud server 220. In some implementations, one or more process blocks of FIG. 4 may be performed by another device or a group of devices separate from or including cloud server 220, such as user device 210.

As shown in FIG. 4, process 400 may include identifying a group of datasets for analysis (block 410). For example, cloud server 220 may identify the group of datasets for analysis. In some implementations, cloud server 220 may receive information identifying the group of datasets. For example, cloud server 220 may provide a user interface, via user device 210, and may receive information identifying a data structure storing one or more datasets. In some implementations, cloud server 220 may obtain one or more datasets, of the group of datasets, from a website. For example, cloud server 220 may receive information, via a user interface provided via user device 210, identifying a website including a dataset, and cloud server 220 may scrape the website or cause a server associated with the website to provide the dataset in a particular format.

In some implementations, cloud server 220 may alter a format of the group of datasets. For example, cloud server 220 may obtain a first dataset in a particular delimited format, and may cause the first dataset to be converted into an Excel type format. In some implementations, cloud server 220 may identify natural language information, such as a text document including a set of statistics, and may parse the text document to generate a second dataset in the Excel type format (or another type of format). In some implementations, cloud server 220 may perform a data mining technique to obtain a particular dataset of the group of datasets.

In some implementations, cloud server 220 may correlate data of the group of datasets. For example, cloud server 220 may determine that a first dataset includes graduation rates for a set of metropolitan areas and a second dataset includes population numbers for the set of metropolitan areas, and cloud server 220 may associate each graduation rate with a corresponding population number. In this way, cloud server 220 determines, for each metropolitan area data entry, a set of metadata entries describing characteristics of the metropolitan area data entry (e.g., a graduation rate metadata entry, a population metadata entry, etc.).

In some implementations, cloud server 220 may correlate the multiple datasets based on a type of analysis that is to be performed. For example, when the type of analysis is associated with selecting a particular location, cloud server 220 may perform a correlation to identify metadata entries (e.g., graduation rate, population, etc.) for location data entries (e.g., each location). Similarly, when the type of analysis is associated with allocating portions of a salary to a set of employees, cloud server 220 may perform a correlation to identify metadata entries (e.g., productivity, years employed, etc.) for employee data entries (e.g., each employee). In this way, cloud server 220 integrates multiple different datasets from multiple different sources into a single group of datasets for performing an analysis.

Additionally, or alternatively, cloud server 220 may determine an approximate correlation between datasets. For example, cloud server 220 may determine that a first dataset includes first data regarding a state, a second dataset includes second data regarding a first city in the state, and the second dataset includes third data regarding a second city in the state. In this case, when cloud server 220 is to perform a selection of a particular city, cloud server 220 may correlate the first data with both the second data (e.g., the first city in the state) and the third data (e.g., the second city in the state), thereby permitting analysis to be performed on both the first city and the second city based on the first data for the state. Similarly, when cloud server 220 is to perform a selection of a particular state, cloud server 220 may correlate the second data and the third data with the first data, thereby permitting analysis to be performed on the state based on the data associated with both the first city and the second city.

As further shown in FIG. 4, process 400 may include identifying a set of filtering criteria for the group of datasets (block 420). For example, cloud server 220 may identify the set of filtering criteria for the group of datasets. The set of filtering criteria may refer to one or more thresholds based on which one or more data entries (and associated metadata of the group of datasets) can be filtered out of a set of data entries. For example, cloud server 220 may identify a threshold graduation rate, and may determine that location data entries that are not associated with a graduation rate metadata entry are to be removed from an analysis.

In some implementations, cloud server 220 may identify the set of filtering criteria based on receiving a user selection. For example, cloud server 220 may provide a user interface, via user device 210, and may receive information identifying one or more filtering criteria via the user interface. Additionally, or alternatively, cloud server 220 may automatically identify one or more filtering criteria. For example, cloud server 220 may obtain information regarding one or more projects, and may generate one or more filtering criteria based on the one or more projects. In this case, for an education project, cloud server 220 may identify one or more other educational projects and may determine that, for the one or more other educational projects, a failure was experienced when a graduation rate failed to exceed a threshold, and may utilize the threshold as a filtering criteria. Similarly, cloud server 220 may determine that a project includes an external funding cost of a threshold amount based on one or more other projects, and may utilize the threshold amount as a filtering criteria (e.g., filtering data entries for which an expected external funding amount does not exceed the threshold amount).

In some implementations, cloud server 220 may parse natural language information to determine a filtering criterion. For example, cloud server 220 may obtain a document, such as a white paper, a news article, a requirements document, or the like, and may parse the document to determine that the document includes a statement that a project is likely to be unsuccessful if a particular criterion is not satisfied. In this case, cloud server 220 may select the particular criterion for filtering data entries from the set of data entries.

In some implementations, cloud server 220 may identify a particular filtering criterion based on a set of metadata values. For example, cloud server 220 may determine, for a particular metadata value, an average value, and may utilize the average value as a threshold to filter associated data entries for which a value of a corresponding metadata does not exceed the threshold value. Additionally, or alternatively, cloud server 220 may determine a median value, a particular percentile value, or the like.

As further shown in FIG. 4, process 400 may include selecting a subset of data entries based on the set of filtering criteria for the group of datasets (block 430). For example, cloud server 220 may select the subset of data entries from a set of data entries based on the set of filtering criteria for the group of datasets. In some implementations, cloud server 220 may select the subset of data entries to omit data from evaluation. For example, cloud server 220 may utilize the filtering criteria to identify one or more data entries for which corresponding groups of metadata entries fail to satisfy the set of filtering criteria, and may remove the one or more data entries from the set of data entries to select the subset of data entries. In this case, cloud server 220 may select a subset of data, associated with the subset of data entries, from data included in the group of datasets for evaluation, and may omit other data included in the group of datasets (e.g., data associated with the one or more data entries) from evaluation. In this way, cloud server 220 reduces a utilization of processing resources for evaluating the group of datasets relative to evaluating all metadata of the group of datasets. In some implementations, cloud server 220 may remove the other data from a memory. For example, cloud server 220 may remove the other data, associated with the one or more data entries, from a data structure storing the group of datasets. In this way, cloud server 220 may reduce a utilization of memory resources relative to storing all metadata of the group of datasets.

As further shown in FIG. 4, process 400 may include evaluating a subset of data included in the group of datasets and associated with the subset of data entries (block 440). For example, cloud server 220 may evaluate the subset of data included in the group of datasets and associated with the subset of data entries. In some implementations, cloud server 220 may evaluate the subset of data to determine a set of scores associated with the subset of data entries. For example, cloud server 220 may apply a set of weights to a set of metadata entries for a particular data entry, and may generate a score for the particular data entry based on applying the set of weights to the set of metadata entries. In this way, cloud server 220 may determine a ranking of the subset of data entries.

Additionally, or alternatively, cloud server 220 may apply a set of weights to subgroups of metadata entries to generate subgroup scores. For example, cloud server 220 may determine that a first subgroup of metadata entries (relating to a particular data entry) are associated with a feasibility of a project and a second subgroup of metadata entries (relating to the particular data entry) are associated with a value of a project. In this case, cloud server 220 may apply a first group of weights to the first subgroup of metadata entries and a second group of weights to the second subgroup of metadata entries to determine a feasibility score and a value score, respectively. In this way, cloud server 220 may generate multiple scores for a particular data entry for evaluating the particular data entry according to multiple criteria. In some implementations, the multiple scores (e.g., multiple component scores relating to multiple data entries, multiple subgroup scores relating to multiple subgroups of data entries of a group of data entries, etc.) may be combined into a composite score.

In some implementations, a metadata entry may be included in multiple subgroups of metadata entries. For example, a graduation rate metadata entry may be determined to be associated with both a feasibility of a project and a value of the project, and cloud server 220 may assign a first weight with regard to a feasibility score of the project and a second, different weight with regard to a value score of the project.

In some implementations, cloud server 220 may determine the set of weights to apply to the set of metadata entries based on other project data. For example, cloud server 220 may determine, based on other project data, an effect of each metadata entry on a characteristic of a corresponding project (e.g., a value of the corresponding project, a feasibility of the corresponding project), and may determine a weight for a particular metadata entry based on a corresponding affect.

Additionally, or alternatively, cloud server 220 may receive information identifying a weight for a particular metadata entry via a user interface. In some implementations, cloud server 220 may obtain a set of weights from another data source. For example, cloud server 220 may parse a document of economic information to identify a formula for calculating a particular score based on values corresponding to metadata entries of a group of metadata entries, may obtain weights associated with the formula, and may utilize the weights to calculate the particular score for each group of metadata entries corresponding to a data entry of the subset of data entries.

In some implementations, cloud server 220 may generate a score for a particular metadata entry. For example, cloud server 220 may determine a value for a particular metadata entry relative to other metadata entries of the same type, and may utilize the value for the particular metadata entry when applying weights to generate a score. In this case, cloud server 220 may determine that a value of the particular metadata entry is in the 90th percentile of values for similar metadata entries, and may assign a relative value of 90 to the particular metadata entry, rather than utilizing the value of the particular metadata entry for applying a weight and generating a score. In this way, cloud server 220 may normalize metadata entry values when generating a score for the metadata entries.

In some implementations, cloud server 220 may evaluate the subset of data to generate a set of tiers for the subset of data entries. For example, cloud server 220 may perform a clustering analysis, a similarity analysis, or the like on the subset of data, the set of scores, or the like, to assign each data entry, of the subset of data entries, to a tier of a set of tiers. Additionally, or alternatively, cloud server 220 may assign the subset of data entries to a set of tiers based on ranking the subset of data entries (e.g., assigning a first hierarchical percentage of data entries to a first hierarchical tier, a second hierarchical percentage of data entries to a second hierarchical tier, etc.). In this way, cloud server 220 may permit analysis of groups of similar scoring data entries.

In some implementations, cloud server 220 may select a particular data entry. For example, cloud server 220 may select the particular data entry associated with the highest relative score, the highest relative composite score, or the like. In some implementations, cloud server 220 may select multiple data entries. For example, cloud server 220 may select multiple data entries associated with a score that satisfies a threshold. Additionally, or alternatively, cloud server 220 may select multiple data entries associated with a particular tier, or the like. In this case, cloud server 220 may provide information regarding the one or more selected data entries, automatically allocate resources to projects associated with the one or more selected data entries, or the like.

As further shown in FIG. 4, process 400 may include providing information based on evaluating the subset of data (block 450). For example, cloud server 220 may provide information based on evaluating the subset of data. In some implementations, cloud server 220 may provide information identifying a set of scores for one or more data entries. For example, cloud server 220 may provide, for display via a user interface of user device 210, information associated with identifying a set of rankings for the subset of data entries based on evaluating the subset of data associated with the subset of data entries. Additionally, or alternatively, cloud server 220 may provide information identifying a set of tiers associated with the subset of data entries. In some implementations, cloud server 220 may provide information identifying one or more data entries not included in the subset of data entries based on the set of filtering criteria. For example, cloud server 220 may provide an indication of data entries that do not satisfy the set of filtering criteria, an indication of a particular metadata entry that does not satisfy a particular filtering criterion for a particular data entry, or the like. In this way, cloud server 220 may permit a user to select one or more data entries that are to be included for analysis despite failing a filtering criterion, thereby providing granular control of analysis.

In some implementations, cloud server 220 may generate, for display via a user interface of user device 210, a graphical plot associated with the subset of data entries based on evaluating the subset of data entries. For example, when cloud server 220 generates a first score relating to a feasibility of implementing a project for the subset of data entries and a second score relating to a value of implementing the project for the subset of data entries, cloud server 220 may generate a graph that plots the first score and the second score for each data entry of the subset of data entries.

In some implementations, cloud server 220 may perform one or more actions based on evaluating the subset of data, and may provide information associated with the one or more response actions. For example, cloud server 220 may allocate a portion of a budget to one or more projects associated with one or more data entries based on evaluating the subset of data entries and based on a corresponding score for the one or more projects. Additionally, or alternatively, cloud server 220 may allocate a first amount of budget to projects categorized into a first tier, a second amount of budget to projects categorized into a second tier, or the like. In this case, cloud server 220 may provide information identifying the allocation of the portion of the budget. Additionally, or alternatively, cloud server 220 may allocate an amount of effort (e.g., a quantity of work hours) to a project associated with a data entry based on evaluating the subset of data entries. Additionally, or alternatively, cloud server 220 may generate a calendar entry for a meeting discussing results of evaluating the subset of data entries, a press release announcing results of evaluating the subset of data entries (e.g., based on an automated natural language generation tool), or the like. Additionally, or alternatively, cloud server 220 may automatically generate a project plan for a project based on selecting a location for the project, may automatically transmit one or more notification messages identifying the selection of the location, may automatically generate and submit one or more forms (e.g., government grant applications, loan applications, etc.), may automatically place one or more advertisements for staff at the location of the project, or the like.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

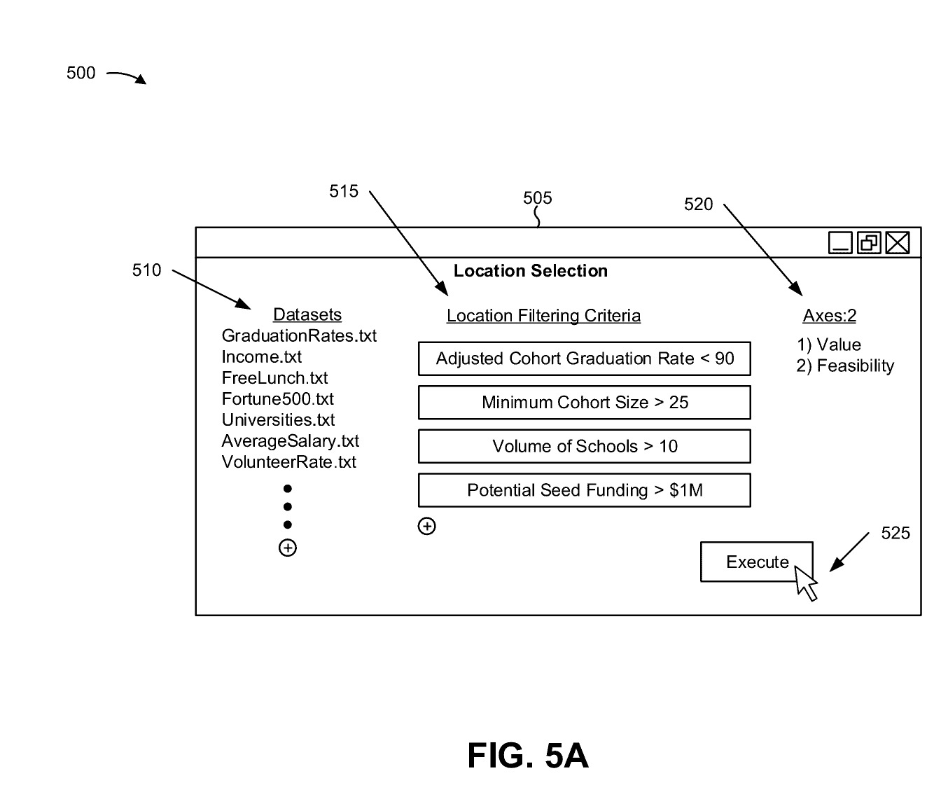

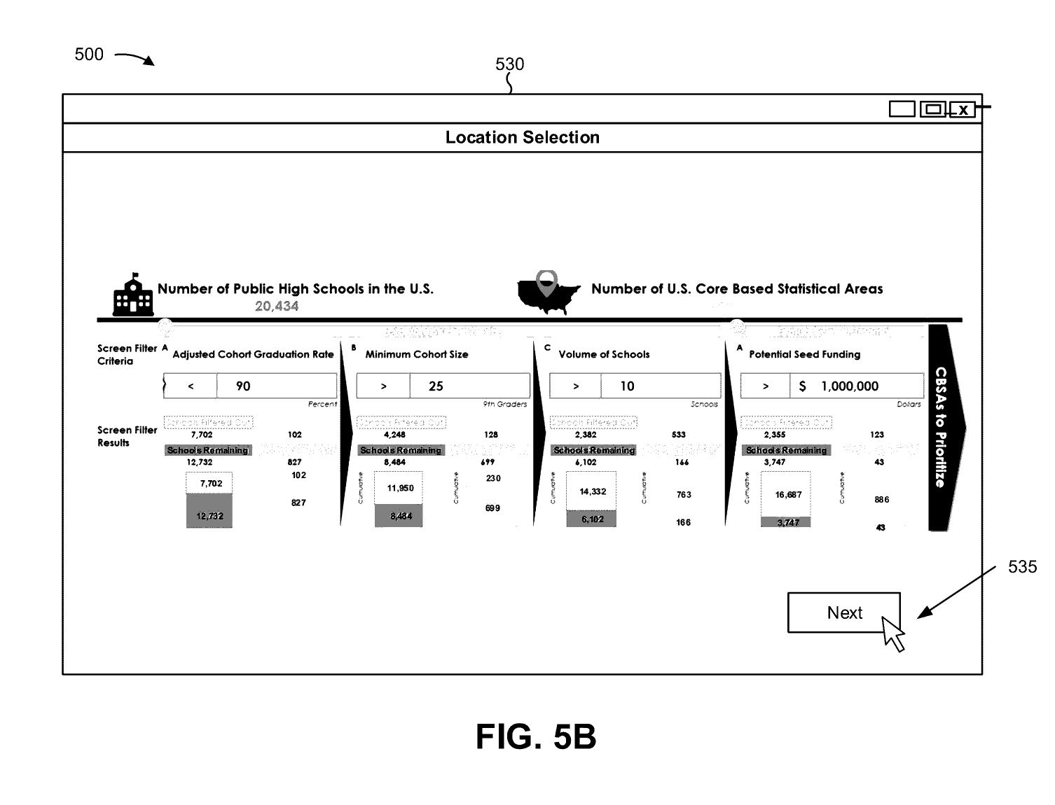

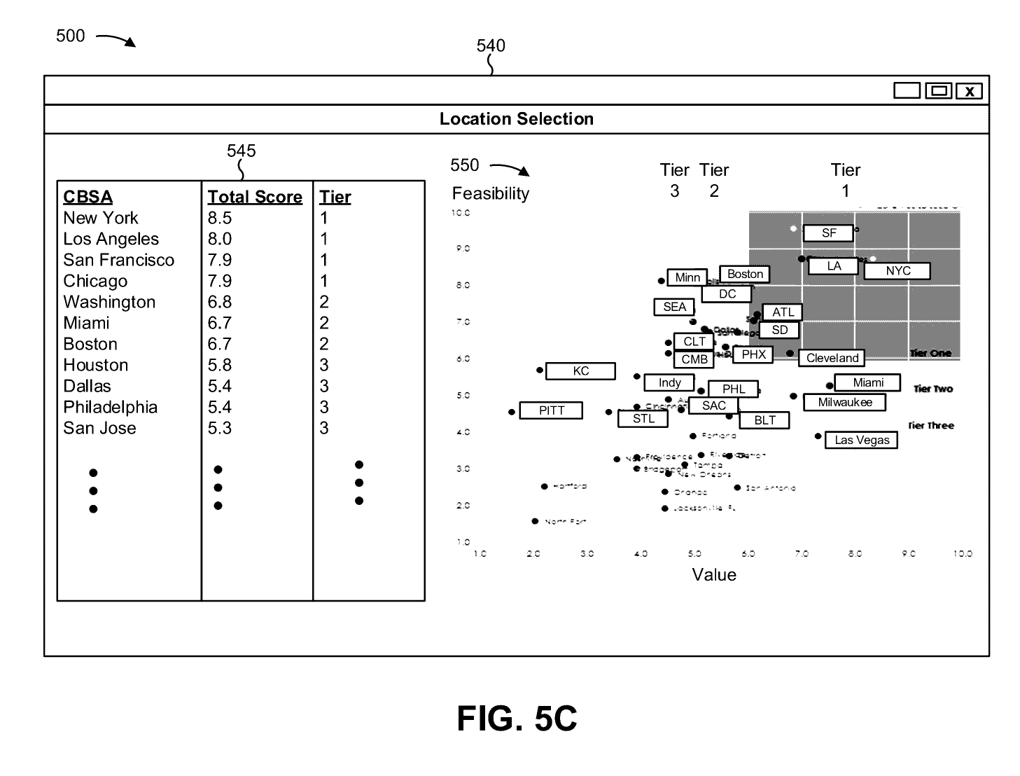

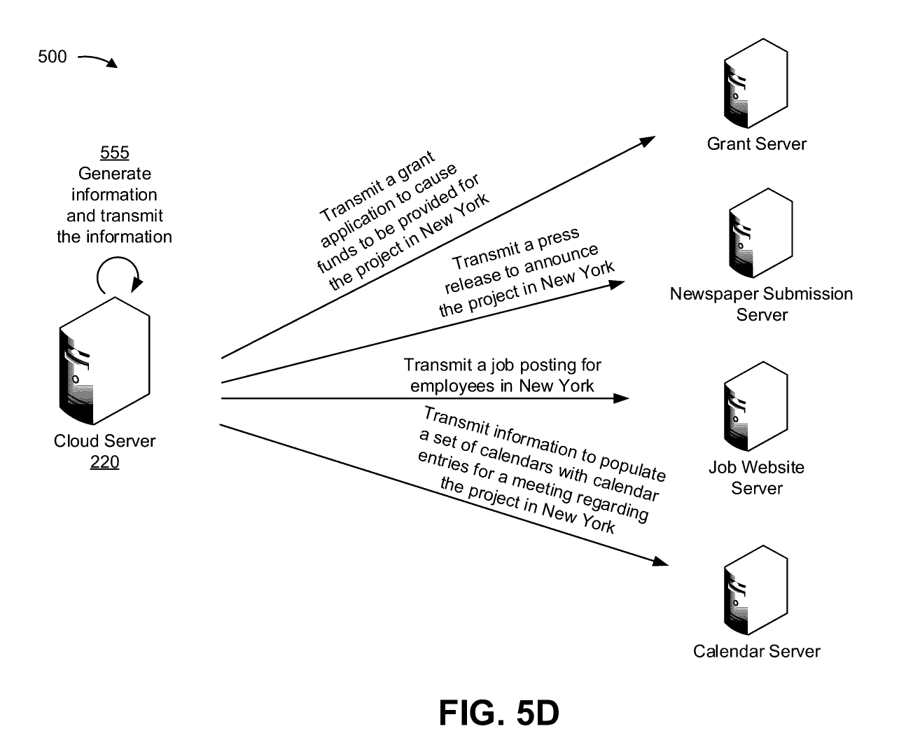

FIGS. 5A-5D are diagrams of an example implementation 500 relating to example process 400 shown in FIG. 4. FIGS. 5A-5D show an example of selecting a data entry from a set of data entries.

As shown in FIG. 5A, cloud server 220 causes a user interface 505 to be provided for display via user device 210. As shown by reference number 510, user interface 505 includes an indication of selected datasets for evaluation. For example, the selected datasets include a dataset of graduation rates at schools at a set of locations (GraduationRates.txt), a dataset of average income levels for people living at a set of locations (Income.txt), a dataset of a percentage of students qualifying for a free lunch program at schools at a set of locations (FreeLunch.txt), or the like. Based on detecting a user interaction with the user interface, cloud server 220 may dynamically update the user interface to include information identifying another dataset that is selected for evaluation.

As further shown in FIG. 5A, and by reference number 515, user interface 505 includes information identifying a set of filtering criteria that are to be utilized to filter the selected datasets. For example, the set of filtering criteria includes selecting schools with less than 90% of students graduating in a particular year, selecting schools with greater than 25 students in each grade, or the like. As shown by reference number 520, user interface 505 includes information identifying a set of scores that cloud server 220 is to determine and graph based on the datasets, such as a Value score and a Feasibility score for each location that satisfies the set of filtering criteria. As shown by reference number 525, based on detecting a user interaction with a user interface, cloud server 220 filters the selected datasets based on the set of filtering criteria to identify a subset of data entries, and evaluates data, of the selected datasets, associated with the subset of data entries.

As shown in FIG. 5B, cloud server 220 causes user interface 530 to be provided for display via user device 210. User interface 530 includes information identifying the data entries (U.S. Core Based Statistical Areas (CBSAs)) from which a particular data entry (e.g., a particular statistical area) is to be selected. User interface 530 provides information identifying data entries that were selected for a subset of data entries that are evaluated and data entries that were filtered from the set of data entries. For example, based on the Adjusted Cohort Graduation Rate filtering criterion, cloud server 220 provides information indicating that 7,702 schools fail to satisfy the filtering criterion resulting in 102 CBSAs being removed from evaluation and that 12,732 schools satisfy the filtering criterion resulting in 827 CBSAs being selected for evaluation. As shown by reference number 535, based on detecting a user interaction with a user interface, cloud server 220 updates user interface 530 to provide further information regarding evaluation of the subset of data.

As shown in FIG. 5C, cloud server 220 causes user interface 540 to be provided for display via user interface device 210. As shown by reference number 545, user interface 540 includes information identifying a ranking of a subset of statistical areas (e.g., CSBAs) not removed from evaluation based on the set of filtering criteria and a set of tiers for the subset statistical areas based on metadata entries associated with the subset of statistical areas. As shown by reference number 550, user interface 550 includes a chart plotting the subset of statistical areas based on the Value score and the Feasibility score. In this way, cloud server 220 provides a user interface including information associated with a decision, such as a decision regarding selecting a location at which to implement a project. Assume that cloud server 220 selects a particular location (e.g., New York) based on the ranking of the subset of statistical areas.

As shown in FIG. 5D, cloud server 220 transmits information to a set of server devices 555 to perform a set of actions. For example, as shown, cloud server 220 automatically generates a grant application for the project including information relating to the particular location, and transmits the grant application for review by a government agency associated with providing a grant. Cloud server 220 automatically generates a press release indicating that the particular location is selected, and transmits the press release to for publication via a set of news sources. Cloud server 220 automatically generates a job posting for employees to manage the project at the particular location, and transmits the job posting to a job listing site. Cloud server 220 automatically generates a set of calendar entries for planning the project at the particular location, and transmits the calendar entries to populate a set of calendars for a set of project stakeholders.

As indicated above, FIGS. 5A-5D are provided merely as an example. Other examples are possible and may differ from what was described with regard to FIGS. 5A-5D.

In this way, cloud server 220 obtains data, filters the data to select a subset of data, and performs an evaluation of the subset of data to generate information regarding the subset of data, thereby permitting a decision regarding selection of a data entry to be performed with a reduced likelihood of error relative to a manual analysis of information. Moreover, based on automatically obtaining datasets, cloud server 220 reduces an amount of processing and network resources that are utilized relative to a user manually searching for and obtaining datasets. Furthermore, based on filtering the datasets, cloud server 220 reduces a memory utilization associated with storing the datasets and a processing resource utilization associated with evaluating the datasets.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, and/or a combination of hardware and software.

Some implementations are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

Certain user interfaces have been described herein and/or shown in the figures. A user interface may include a graphical user interface, a non-graphical user interface, a text-based user interface, etc. A user interface may provide information for display. In some implementations, a user may interact with the information, such as by providing input via an input component of a device that provides the user interface for display. In some implementations, a user interface may be configurable by a device and/or a user (e.g., a user may change the size of the user interface, information provided via the user interface, a position of information provided via the user interface, etc.). Additionally, or alternatively, a user interface may be pre-configured to a standard configuration, a specific configuration based on a type of device on which the user interface is displayed, and/or a set of configurations based on capabilities and/or specifications associated with a device on which the user interface is displayed.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A device, comprising:
one or more processors to:
communicate with one or more data sources to obtain data from the one or more data sources,
the data including a set of data entries,
the data including a set of groups of metadata entries,
a group of metadata entries, of the set of groups of metadata entries, corresponding to a data entry of the set of data entries;
determine a set of filtering criteria associated with filtering the data;
process the data to select a subset of data entries, of the data, based on the set of filtering criteria,
the subset of data entries corresponding to a subset of groups of metadata entries of the set of groups of metadata entries;
automatically evaluate the subset of groups of metadata entries to determine a set of scores for the subset of data entries; and
provide, for display via a user interface, information identifying the set of scores for the subset of data entries.

2. The device of claim 1, where the set of scores is a first set of scores relating to a first characteristic of the subset of data entries; and
where the one or more processors are further to:
generate a second set of scores for the subset of data entries relating to a second characteristic of the subset of data entries; and
where the one or more processors, when providing information, are to:
generate a plot of the first set of scores and the second set of scores,
the first set of scores being associated with a first axis of the plot,
the second set of scores being associated with a second axis of the plot.

3. The device of claim 1, where the one or more processors are further to:
categorize the subset of data entries into a set of tiers based on automatically evaluating the subset of metadata entries,
each tier, of the set of tiers, including a group of data entries with a score within a threshold quantity; and
provide, for display via the user interface, information identifying the set of tiers.

4. The device of claim 1, where the one or more processors, when communicating with the one or more data sources to obtain the data, are to:
obtain, via the user interface, information identifying a location of a particular data source of the one or more data sources; and
automatically obtain, from the location of the particular data source, data regarding the set of data entries.

5. The device of claim 1, where the one or more processors are further to:
determine that a first dataset, of the data, is associated with a first format and that a second dataset, of the data, is associated with a second format; and
alter a format of the first dataset or the second dataset to generate altered data associated with a common format,
the common format being usable to process the data to select the subset of data entries.

6. The device of claim 1, where the one or more processors are further to:
determine that a first metadata entry of a first data set and a second metadata entry of a second data set are each associated with a particular data entry of the set of data entries; and
correlate the first metadata entry with the second metadata entry to generate a particular group of metadata entries for the particular data entry,
the particular group of metadata entries being included in the group of metadata entries.

7. The device of claim 1, where the one or more processors, when automatically evaluating the subset of groups of metadata entries, are to:
rank, for a particular type of metadata entry, each metadata entry of the particular type of metadata entry included in the subset of groups of metadata entries;
determine, based on ranking of each metadata entry of the particular type of metadata entry, a metadata entry score;
determine a particular score, of the set of scores, based on the metadata entry score; and
where the one or more processors, when providing information identifying the set of scores, are to:
provide information identifying the particular score.

8. A non-transitory computer-readable medium storing instructions, the instructions comprising:
one or more instructions that, when executed by one or more processors, cause the one or more processors to:
obtain a plurality of datasets relating to a plurality of characteristics of a set of locations for a project,
one or more datasets, of the plurality of datasets, being stored via one or more data structures;
correlate metadata entries, of the plurality of datasets, into groups of metadata entries,
a group of metadata entries relating to the plurality of characteristics of a particular location of the set of locations;
select, from the set of locations, a subset of locations based on a set of filtering criteria;
evaluate a subset of groups of metadata entries, of the groups of metadata entries, that are associated with the subset of locations; and
provide information identifying one or more locations, of the subset of locations, for the project,
the information identifying the one or more locations including information identifying a feasibility of implementing the project at the one or more locations and a value of implementing the project at the one or more locations.

9. The computer-readable medium of claim 8, where the one or more instructions, that cause the one or more processors to evaluate the subset of groups of metadata entries, cause the one or more processors to:
determine a score for each metadata entry of a particular group of metadata entries associated with a particular location of the subset of locations;
determine a composite score for the particular location based on the score for each metadata entry; and
where the one or more instructions, that cause the one or more processors to provide information identifying the one or more locations, cause the one or more processors to:
provide information identifying the particular location based on the composite score for the particular location.

10. The computer-readable medium of claim 9, where the one or more instructions, when executed by the one or more processors, further cause the one or more processors to:
apply a set of weights to the score for each metadata entry to generate a weighted score for each metadata entry; and
where the one or more instructions, that cause the one or more processors to determine the composite score for the particular location, cause the one or more processors to:
determine the composite score based on the weighted score for each metadata entry.

11. The computer-readable medium of claim 8, where a particular group of metadata entries, of the subset of groups of metadata entries and associated with a particular location of the subset of locations, includes a plurality of metadata entries; and
where the one or more instructions, that cause the one or more processors to evaluate the subset of groups of metadata entries, cause the one or more processors to:
assign a first one or more metadata entries, of the plurality of metadata entries, to a first sub-group of metadata entries;
determine a first score for the particular location based on the first sub-group of metadata entries,
the first score corresponding to the feasibility of implementing the project at the particular location;
assign a second one or more metadata entries, of the plurality of metadata entries, to a second sub-group of metadata entries;
determine a second score for the particular location based on the second sub-group of metadata entries,
the second score corresponding to the value of implementing the project at the particular location; and
where the one or more instructions, that cause the one or more processors to provide information identifying the one or more locations, cause the one or more processors to:
provide information identifying the particular location based on the first score and the second score.

12. The computer-readable medium of claim 11, where the one or more instructions, when executed by the one or more processors, further cause the one or more processors to:
determine a composite score based on the first score and the second score;
determine a ranking of the subset of locations based on the composite score and one or more other composite scores associated with one or more other locations of the subset of locations;
select the one or more locations of the subset of locations based on the ranking of the subset of locations; and
where the one or more instructions, when executed by the one or more processors, cause the one or more processors to:
provide information identifying the one or more locations based on selecting the one or more locations,
the information identifying the one or more locations including information identifying the ranking of the subset of locations.

13. The computer-readable medium of claim 8, where the one or more instructions, that cause the one or more processors to obtain the plurality of datasets, cause the one or more processors to:
perform a data mining technique to obtain data for a particular dataset of the one or more datasets.

14. The computer-readable medium of claim 8, where the one or more instructions, when executed by the one or more processors, further cause the one or more processors to:
automatically allocate a budget to the one or more locations based on evaluating the subset of groups of metadata entries that are associated with the subset of locations; and
where the one or more instructions, that cause the one or more processors to provide information identifying the one or more locations, cause the or more processors to:
provide information identifying the budget based on automatically allocating the budget.

15. A method, comprising:
identifying, by a device, a group of datasets relating to a decision to implement a program,
the group of datasets including groups of metadata entries regarding a set of data entries;
determining, by the device, a set of filtering criteria relating to the decision to implement the program;
selecting, by the device, two or more groups of metadata entries, of the groups of metadata entries, that satisfy the set of filtering criteria,
the two or more groups of metadata entries relating to two or more data entries of the set of data entries;
evaluating, by the device, the two or more groups of metadata entries to generate two or more scores corresponding to the two or more data entries,
a score, of the two or more scores, being a composite score based on two or more component scores,
each component score, of the two or more component scores, being related to a value of a particular metadata entry, of a particular group of metadata entries, relative to one or more values of one or more other corresponding metadata entries of one or more other groups of metadata entries of the two or more groups of metadata entries;
providing, by the device, information identifying the two or more scores.

16. The method of claim 15, further comprising:
assigning each metadata entry, of the particular group of metadata entries, to a subgroup of metadata entries of two or more subgroups of metadata entries,
the two or more subgroups of metadata entries relating to two or more characteristics of the decision to implement the project;
determining, for the particular subgroup of metadata entries, a subgroup score based on one or more component scores for one or more metadata entries of the particular subgroup of metadata entries; and
where evaluating the two or more groups of metadata entries comprises:
determining the score based on the subgroup score and one or more other subgroup scores.

17. The method of claim 16, where assigning each metadata entry to a subgroup of metadata entries comprises:
assigning a particular metadata entry, of the particular group of metadata entries, to two or more subgroups of metadata entries of a plurality of subgroups of metadata entries.

18. The method of claim 17, further comprising:
assigning a first weight to the particular metadata entry for determining a first subgroup score for a first subgroup of metadata entries of the two or more subgroups of metadata entries; and
assigning a second weight to the particular metadata entry for determining a second subgroup score for a second subgroup of metadata entries of the two or more of subgroups of metadata entries,
the first weight being different from the second weight; and
where determining the score comprises:
determining the score based on the first subgroup score and the second subgroup score.

19. The method of claim 15, where the decision to implement the project relates to selecting a location and each data entry of the set of data entries corresponds to a location; and
the method further comprising:
selecting a particular location based on the two or more scores; and
providing information identifying the particular location.

20. The method of claim 15, further comprising:
providing information identifying one or more data entries, of the set of data entries, for which a corresponding one or more groups of metadata entries, of the groups of metadata entries, are not selected for the two or more of groups of metadata entries.
